(19) United States
(12) Patent Application Publication
(10) Pub. No.: US 2005/0276884 A1
(43) Pub. Date: Dec. 15, 2005

(54) Customizable food and personal care products

(75) Inventor: Andrew Schydlowsky, Santa Barbara, CA (US)

Correspondence Address: FISH & RICHARDSON P.C., PO BOX 1022, MINNEAPOLIS, MN, 55440-1022, US

(73) Assignee: Kala International, Ltd., Santa Barbara, CA (US)

(21) Appl. No.: 11/167,891

(22) Filed: Jun. 27, 2005

Related U.S. Application Data
(63) Continuation-in-part of application No. 10/697,767, filed on Oct. 30, 2003.
(60) Provisional application No. 60/456,900, filed on Mar. 21, 2003.

(51) Int. Cl. C12C 1/027

(52) U.S. Cl. 426/106

(57) ABSTRACT

Customizable foods and customizable personal care products are provided, which include a base component and at least one packaged additive.

### CROSS REFERENCE TO RELATED APPLICATION

This application is a continuation-in-part of and claims priority under 35 U.S.C. § 120 to U.S. application Ser. No. 10/697,767, filed Oct. 30, 2003, which claims priority to U.S. Provisional Application No. 60/456,900, filed Mar. 21, 2003, both of which are incorporated by reference in their entirety herein.

### TECHNICAL FIELD

This invention relates to food products and personal care products, and more particularly to customizable food and personal care products and kits containing the same.

### BACKGROUND

A variety of additives are included in food products, ranging from flavorants and colorants to preservatives, texturizers and the like. Most, if not all of these, are generally added to the food product prior to distribution to the consumer, so that the food item is distributed and marketed specifically as having a particular flavor, odor, taste, shelf-life, etc. For example, a carton of chocolate milk is typically provided having chocolate or cocoa flavorant mixed into milk, along with an amount of preservative and possibly coloring agents. Flavors or flavor enhancers are also often to disguise or overcome an unpalatable taste. For example, over-the-counter and prescription medicines often include an active ingredient with a bitter taste. Because children can be resistant to consume a bitter medicinal formulation, manufacturers often sweeten, flavor (e.g. grape, bubble gum, orange, cherry), and sometimes color the medicinal formulation prior to distribution to the consumer.

Similarly, personal care products are also prepared for distribution to the consumer having a defined color, texture, and fragrance. For example, shampoos, conditioners, body washes and gels, perfumes, body scrubs, cosmetics (lipsticks, glosses, eye shadow), facial creams, and body creams are often marketed to the consumer with varied fragrances, colors, and textures. Thus, eye shadows are typically sold in small volumes of defined color, and consumers typically buy a number of individual units in order to achieve the color palette desired.

A limitation to pre-mixed products with pre-mixed additives, however, is that a consumer needs to purchase multiple items of similar products in different varieties in order to satisfy his desire for different flavors, colors, textures, odors, or shelf-life. For example, a parent of a set of siblings, each of whom has different flavor preferences, would need to purchase at least two different bottles of, for example, cough syrup—one having a fruit flavor and one having a bubble gum flavor.

Certain manufacturers have attempted to satisfy customers needing multiple varieties by packaging an assortment of the same product in a collection or cluster. For example, packets of assorted flavored oatmeal can be found in one box, and multiple colors of eyeshadow are often sold as a single product. Assortment collections such as these, however, can add printing, processing, and other costs. Furthermore, certain flavors, colors, or fragrances included in the assortment may not necessarily be those desired by the consumer, and therefore remain unused.

### SUMMARY

Provided herein are kits to prepare customizable foods or personal care products. Examples of customizable food include, without limitation, a nutritional supplement, a dairy item, a dry goods item, a medicine, or a marinade. Customizable personal care products include, without limitation, shampoos, conditioners, body washes and gels, perfumes, body scrubs, cosmetics (lipsticks, glosses, eye shadow), facial creams, and body creams.

In one embodiment, a kit for making a customizable food is provided. The kit includes a base component. A base component can be a solid, semi-solid, gel, liquid, or powder. A base component is typically provided in multiples of individual serving or preparation amounts. For example, a base component can be included in an amount sufficient to provide at least two, three, four, five, six, seven, eight, nine, ten or more servings of a customizable food.

A kit can also include at least one packaged additive. In certain cases, a plurality of packaged additives is included. The at least one packaged additive can be chosen by the consumer or purchaser. The at least one packaged additive can include one or more of a colorant, flavorant, texture modifier (e.g., beads, spheres, particles, rheology-modifying agents), preservative, or fragrance.

The at least one packaged additive can be combined with a portion of the base component to alter a characteristic of that portion of the base component. A characteristic that can be altered can be, without limitation, taste, color, odor, shelf-life, and texture.

In some cases, the number of the plurality of packaged additives is equal to the number of individual servings or preparations of the base component. For example, if the base component is provided in an amount to provide four servings of a customizable food, then four packaged additives can be included in the kit. In other cases, the number of the plurality of packaged additives is equal to a multiple (e.g., 2×, 3×, 4×, 5×, 6× or more) of the number of individual servings or preparations of the base component. For example, if the base component is provided in an amount to provide four servings of a customizable food, then eight (i.e., 2× number of servings of the base component) packaged additives can be included in the kit. In such a case, for example, one packaged additive may be used to alter the color and another packaged additive may be used to alter the flavor of an individual portion of the base component.

In some cases, the number of packaged additives is equal to one. In such cases, the total amount of ingredients in the at least one packaged additive is sufficient, when apportioned appropriately, to alter a characteristic of the number of individual serving sizes or preparation amounts provided for the base component. For example, if 100 grams of a base component is provided, with 25 g being a single serving size, 20 grams total of the at least one packaged additive can be provided, with 5 grams of the additive added to the 25 g of base component per serving.

The at least one packaged additive (or plurality of packaged additives) is packaged separately from the base component. For example, in some cases, a kit can include a holder adapted to hold the at least one packaged additive, e.g., a holder integral with the base component.

In another aspect, a kit for making a customizable nutritional supplement is provided. The kit includes a dietary supplement base component and at least one additive, e.g., at least one flavorant additive. Kits for making a customizable marinade and a customizable medicine, among other customizable foods, are also provided.

In other embodiments, kits for making customizable personal care products are also provided. Customizable personal care products include, without limitation, shampoos, conditioners, body washes and gels, perfumes, body scrubs, cosmetics (lipsticks, glosses, eye shadow), facial creams, and body creams. The kit includes a base component. A base component can be a solid, semi-solid, gel, liquid, or powder. A base component is typically provided in multiples of individual use amounts. For example, a base component can be included in an amount sufficient to provide two, three, four, five, six, seven, eight, nine, ten, fifteen, twenty, twenty-five, thirty, thirty-five, forty, forty-five, fifty, or more uses of a customizable personal care product.

A kit for preparing a customizable personal care product can also include at least one packaged additive. In certain cases, a plurality of packaged additives is included. The at least one packaged additive can be, individually, a colorant, texture modifier (e.g., beads, spheres, particles, rheology-modifying agents), preservative, or fragrance.

The at least one packaged additive can be combined with a portion of the base component to alter a characteristic of the base component. A characteristic that can be altered can be, without limitation, color, odor, shelf-life, and texture.

In some cases, the number of the plurality of packaged additives is equal to the number of individual uses of the base component. For example, if the base component is provided in an amount to provide twenty uses of a customizable personal care product, then twenty packaged additives can be included in the kit. In other cases, the number of the plurality of packaged additives is equal to a multiple (e.g., 2×, 3×, 4×, 5×, 6× or more) of the number of individual uses of the base component. For example, if the base component is provided in an amount to provide twenty uses of a customizable personal care product, then forty (i.e., 2× number of uses of the base component) packaged additives can be included in the kit. In such a case, for example, one packaged additive may be used to alter the color and another packaged additive may be used to alter the fragrance of an individual use of the base component.

In some cases, the number of packaged additives is equal to one. In such cases, the total amount of ingredients in the at least one packaged additive is sufficient, when apportioned appropriately, to alter a characteristic of the number of individual uses provided for the base component. For example, if 100 grams of a base shampoo component is provided, with 5 g being an individual use, 20 grams total of the at least one packaged additive can be provided, with 1 gram of the additive added to the 5 g of base component per use.

The at least one packaged additive (or plurality of packaged additives) is packaged separately from the base component. For example, in some cases, a kit can include a holder adapted to hold the at least one packaged additive, e.g., a holder integral with the base component.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is an illustration of a packaged article according to an embodiment of the invention.

FIG. 1B is an illustration of another packaging alternative according to an embodiment of the invention.

FIG. 2 is an illustration of an exemplary package for an additive according to the invention.

FIG. 3 is an illustration of a display according to an embodiment of the invention.

### DETAILED DESCRIPTION

Provided herein are kit that allows a user to customize one or more characteristics of a product's base component according to the user's personal desire. Customizing a food or personal care base component, sometimes referred to herein as a “base,” can be accomplished by providing an additive suitable for combining with the base. By keeping a base and at least one additive separate until, for example, just prior to consuming or using the product, a user can advantageously make customizable products to suit his desires. Furthermore, the user is not limited to certain variations of a product, but rather, can be empowered to make a large number of variations and combinations.

Customizable Foods

According to one aspect, a kit for making a customizable food is provided. Customizable foods include, but are not limited to, medicines, marinades, nutritional supplements, condiments (e.g., mustards, mayonnaises, ketchups, salsas), dry goods, soups, and dairy items (e.g., milk, half-and-half, sour cream, butter, margarine, cream cheese, yogurt, yogurt drinks).

A kit for preparing a customizable food includes a base component. A base component can include certain constituents, yet has the capacity to be combined or blended with at least one additive to achieve a customizable food. A base can be provided in any form such as a solid, semi-solid, liquid, gel, or powder. A base component is typically provided in multiples of individual serving or preparation (e.g., family size) amounts. For example, a base component can be included in an amount sufficient to provide two, three, four, five, six, seven, eight, nine, ten or more servings or preparation amounts of a customizable food.

A kit for preparing a customizable food can also include at least one packaged additive. In certain cases, a plurality of packaged additives is included. As used herein, an “additive” refers anything that can be included in a customizable food that would alter, directly or indirectly, a characteristic of the base component. Exemplary characteristics include, but are not limited to, flavor, color, odor, shelf-life, or texture of the base component. Additives suitable for combining with a base component therefore include, for example, flavorants, colorants, preservatives, texture modifiers (e.g., beads, spheres, particles, rheology-modifying agents), and combinations thereof.

Alternatively, an additive can include an active constituent of a base component itself, whereby the inclusion of an additive to the base component increases the concentration of the active constituent. For example, a nutritional supplement that typically includes active constituents such as carbohydrates, vitamins, minerals, salts, electrolytes, phytoceuticals (e.g., herbs, Echinacea, ginger, ginseng, ginko biloba, and creatine), proteins (e.g., whey protein, soy protein, fish protein, beef protein, egg protein, chicken protein, amino acids (including taurine, non-natural amino acids, and natural amino acids, such as branched chain amino acids), and peptides can be provided as a customizable kit herein by providing a dietary supplement base that does not include or includes a lower concentration of one or more of such active constituents, with one or more of such active constituents as packaged additives for inclusion by the consumer at a later time after purchase.

An additive can be provided in any suitable form that allows it to be added to the base component. Thus, the additive can be, for example, in a solid, semi-solid, gel-like, liquid, or powder form. The additive can be added to the base component using various techniques, such as, for example, combining, coating, admixing, applying, or combinations thereof. Preferred techniques are those that require minimal equipment or appliances and minimal time, for the convenience of the user. For example, simply mixing the additive with a spoon, or spreading the additive with a knife are convenient methods. However, rapid mixing with a blender or mixer can also be used, if desired.

As will be recognized by one having ordinary skill in the art, the nature of the at least one packaged additive as one or more of a colorant, flavorant, texture modifier, preservative, or fragrance, will depend on the nature of the customizable food, consumer preference, organoleptic considerations, etc. Combinations of additives can also be used, e.g., 1 flavorant additive, 1 colorant additive, 1 texture modifier, etc.

In some cases, the number of the plurality of packaged additives is equal to the number of individual servings or preparations of the base component. For example, if the base component is provided in an amount to provide four servings of a customizable food, then four packaged additives can be included in the kit. In other cases, the number of the plurality of packaged additives is equal to a multiple (e.g., 2×, 3×, 4×, 5×, 6× or more) of the number of individual servings or preparations of the base component. For example, if the base component is provided in an amount to provide four servings of a customizable food, then eight (i.e., 2× number of servings of the base component) packaged additives can be included in the kit. In such a case, for example, one packaged additive may be used to alter the color and another packaged additive may be used to alter the flavor of an individual portion of the base component.

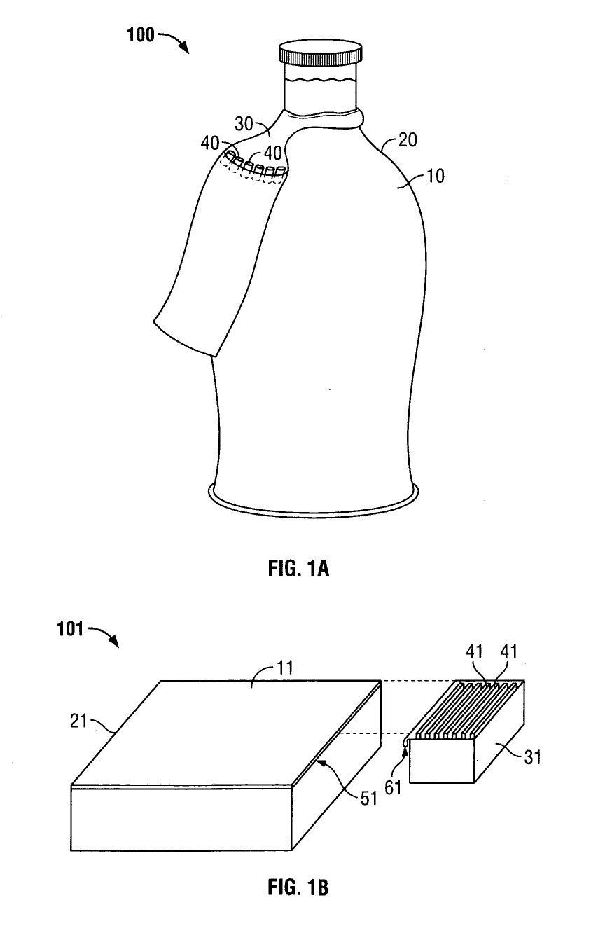

The at least one packaged additive (or plurality of packaged additives) is packaged separately from the base component. For example, in some cases, a kit can include a holder adapted to hold the at least one packaged additive, e.g., a holder integral with the base component. See FIGS. 1-3 and the description below.

In one example, a kit for a customizable nutritional supplement is provided, which includes a dietary supplement base. The dietary supplement base can be in liquid, powder, or gel form. Such a base can include ingredients typically included in a dietary supplement, including one or more active ingredients selected from peptides, proteins, amino acids, vitamins, minerals, carbohydrates, phytoceuticals, nutraceuticals, electrolytes, salts, and other active constituents as described previously, or combinations thereof. Formulations for dietary supplement bases are well known to those having ordinary skill in the art; see, e.g., U.S. Patent Publications 2005/0112177; 2005/0037065; and 2005/0032757; and U.S. Pat. Nos. 6,899,891; 6,861,554; 6,903,136; and 6,818,233.

Such a kit also contains at least one packaged additive, such as at least one flavorant or at least one active constituent. In certain cases, the dietary supplement base is apportionable into single servings and the number of individually packaged additives is equal to at least the number of single servings of the dietary supplement base. For example, the dietary supplement base can be apportionable into 10 servings, with 10 packaged flavorants included in the kit.

In certain embodiments, dietary supplement bases can be packaged with additives selected from a sweetener and a flavorant. Natural or artificial sweeteners can be used. Suitable flavorants include, but are not limited to, chocolate, vanilla, fruits (e.g. strawberry, banana, peach, orange, cherry, blueberry, raspberry, mango, apple, pineapple, grape, etc.), peanut butter, mint, caramel, cinnamon, mocha, and combinations thereof.

Another example of a kit for preparing a customizable food includes a container of a marinade base component. A marinade base component can include oil and vinegar. The oil can be any edible oil, e.g., corn, canola, olive, safflower, walnut, macadamia nut, peanut, soybean, almond, coconut, grapeseed, palm, and sunflower. The vinegar can be any vinegar, including wine (red, white), white, balsamic, champagne, sherry, malt, cider, rice, umeboshi, cane, and coconut vinegars. The volume of marinade base component provided can be sufficient to provide two or more servings of a marinade for separate use. For example, a serving size of the marinade could be sufficient for a kilogram of meat, fish, or poultry.

A marinade kit would further include at least one packaged additive, such as flavorants, colorants, or texture modifiers. In certain cases, the at least one packaged additive can be a flavorant additive, such as a package of soy sauce, fish sauce, chili sauce, chili garlic sauce, peanut sauce, teriyaki sauce, citrus juice or concentrate (e.g., lemon, lime, orange), vinegar (e.g., as described previously), sugar (e.g., brown sugar), shredded citrus (e.g., lemon, lime, orange) peel, one or more herbs and/or spices, fruits (e.g., dried fruits such as apricots, raisins, cranberries, raspberries, blueberries, cherries, apples), nuts, garlic, onion, mustard, catsup, or vegetables (e.g., dried vegetables such as carrots, tomatoes, peppers, eggplant, potatoes, and parsnips). In some cases, the at least one packaged additive can be a texture modifier, e.g., starch, pectin, and/or oils. By providing at least one and optionally a plurality of additive packages, a variety of marinades can therefore be made from the single container of the base marinade component.

In certain embodiments, a kit provided herein includes a base component that can be classified as a dry good. This class can include foods such as oatmeal, cereals, grains, flours, rices, pastas, dried potatoes, and other typically non-perishable, dry items, or mixtures thereof. For example, a base component can be a dry baking mix such as those for bread, cake, brownies, and cookies. In other cases, the base component can be a pasta, a rice, an oatmeal, a grain, or dried potatoes. Such kits can include at least one packaged additive, e.g., flavorant packaged additives. Examples of such flavorant packaged additives include meats (e.g., dehydrated meats), fruits, nuts, spices, herbs, oils, fats, chocolate bits, white chocolate bits, sprinkles, frostings, icings, sweeteners (e.g., sugars), and syrups. Typically, in such cases, a base component is provided in multiple single or family-size servings, with the number of packaged additives at least equivalent to the number of single or family-size servings.

Another example is a kit for preparing a customizable medicine. Such kits can be useful for preparing medicines having a desired color, flavor, texture, fragrance, and/or shelf-stability. The kit can include any base medicine component, including, without limitation, an NSAID, a steroid, an antibiotic, a pain killer, a fever reducer, an anti-emetic, an emetic, an anti-diarrheal, etc. Typical examples of specific medicines include albuterol, augmentic, amoxicillin, penicillin, bactrim, biaxin, ceftin, cephalexin, cleocin, erythromycin, phenobarbital, guaifenesin, liquid vitamins, zantac, vantin, zithromax, bi-citra or poly citra, haldol, imodium, theophylline, and naprosyn.

A kit for preparing a customized medicine can also include at least one packaged additive. The at least one packaged additive can be a flavorant, e.g., a flavorant that provides an apple, banana, banana-orange, berry, blackberry, blueberry, cherry, strawberry, raspberry, bubblegum, fruit punch, butterscotch, chocolate, mint, cinnamon, citrus punch, cotton candy, grape, orange, peach, peanut butter, mango, caramel, mocha, vanilla, coffee, pina colada, orange-cream, pineapple, or watermelon flavor to the base medicine component. The at least one packaged additive can be a colorant, e.g., to provide a red, blue, purple, yellow, orange, violet, cream, or green color to the base medicine component. The at least one packaged additive can be a fragrance, e.g., to provide a range of fragrances as the previously described flavors, e.g., apple, banana, banana-orange, berry, blackberry, blueberry, cherry, strawberry, raspberry, bubblegum, fruit punch, butterscotch, chocolate, mint, cinnamon, citrus punch, cotton candy, grape, orange, peach, peanut butter, mango, caramel, mocha, vanilla, coffee, pina colada, orange-cream, pineapple, or watermelon fragrance. In certain cases, the at least one packaged additive is a preservative, e.g., to alter the shelf-stability of the base medicine component once it is formulated, e.g., as an aqueous formulation. Texture-modifiers can also be included as an at least one packaged additive, e.g., to alter the viscosity of a base medicine component.

Kits for preparing customized dairy items are also provided. Exemplary customizable dairy items include, without limitation, milk, half-and-half, sour cream, butter, margarine, cream cheese, yogurt, and yogurt drinks. A kit for preparing a customizable dairy item can include a dairy item and at least one packaged additive. For example, a kit can include a milk base component, e.g., having 8 single servings of milk, with 8 packaged flavorant additives, e.g., two strawberry, two chocolate, two coffee, and two vanilla flavorant packages. One example of a kit for preparing a customizable yogurt drink can include a base yogurt drink component, e.g., for preparing 4 servings of a yogurt drink, with 4 packaged flavorant additives, e.g., strawberry, raspberry, mango, and vanilla. A kit for preparing a customizable yogurt can include a base yogurt component, e.g., for providing 4 servings of yogurt, with 4 packaged flavorant additives, e.g., cherry, blueberry, apple, and coffee. As indicated previously, the at least one packaged additive is not limited to flavorants, but could include colorants, fragrances, texture modifiers, or preservatives, or mixtures thereof.

Customizable Personal Care Products

According to one aspect, a kit for making a customizable personal care product is provided. Customizable personal care products include, without limitation, shampoos, conditioners, body washes and gels, body fragrances (e.g., perfumes), body scrubs, cosmetics (lip glosses, eye shadows), facial creams, and body creams.

A kit for preparing a customizable personal care product includes a base component. A base component can include certain constituents, yet has the capacity to be combined or blended with at least one additive to achieve a customizable personal care product. A base can be provided in any form such as a solid, semi-solid, liquid, gel, or powder. A base component is typically provided in multiples of individual use or preparation amounts. For example, a base component can be included in an amount sufficient to provide five, ten, fifteen, twenty, twenty-five, thirty, forty, fifty, or more uses of a customizable personal care product.

A kit for preparing a customizable personal care product can also include at least one packaged additive. In certain cases, a plurality of packaged additives is included. As used herein, an “additive” refers anything that can be included in a customizable personal care product that would alter, directly or indirectly, a characteristic of the base component. Exemplary characteristics include, but are not limited to flavor, color, odor, shelf-life, or texture of the base component. Additives suitable for combining with a base component therefore include, for example, flavorants, colorants, preservatives, texture modifiers (e.g., beads, spheres, particles, rheology-modifying agents), and combinations thereof.

An additive can be provided in any suitable form that allows it to be added to the base component. Thus, the additive can be, for example, in a solid, semi-solid, gel-like, liquid, or powder form. The additive can be added to the base component using various techniques, such as, for example, combining, coating, admixing, applying, or combinations thereof. Preferred techniques are those that require minimal equipment or appliances and minimal time, for the convenience of the user.

The nature of the at least one packaged additive as one or more of a flavorant, colorant, texture modifier, preservative, or fragrance, will depend on the nature of the customizable personal care product, consumer preference, etc. Combinations of additives can also be used, e.g., 1 colorant additive, 1 texture modifier, etc.

In some cases, the number of the plurality of packaged additives is equal to the number of individual uses of the base component. For example, if the base component is provided in an amount to provide 10 uses of a customizable personal care product, then four packaged additives can be included in the kit. In other cases, the number of the plurality of packaged additives is equal to a multiple (e.g., 2×, 3×, 4×, 5×, 6× or more) of the number of individual uses of the base component. For example, if the base component is provided in an amount to provide 10 uses of a customizable personal care product, then twenty (i.e., 2× number of uses of the base component) packaged additives can be included in the kit. In such a case, for example, one packaged additive may be used to alter the color and another packaged additive may be used to alter the fragrance of an individual portion of the base component.

The at least one packaged additive (or plurality of packaged additives) is packaged separately from the base component. For example, in some cases, a kit can include a holder adapted to hold the at least one packaged additive, e.g., a holder integral with the base component. See FIGS. 1-3 and the description below regarding kits and packaging.

In one example, a kit for a customizable shampoo is provided, which includes a cleansing formulation base. The cleansing formulation base can be in liquid or gel form. Such a base can include ingredients typically included in a cleansing formulation, including one or more active ingredients selected from one or more surfactants (nonionic, anionic, and amphoteric) and viscosity and rheology modifiers (e.g., electrolytes (e.g., NaCl), non-ionic compounds, and betaines (e.g., lauryl betaine, cocamidopropyl betaine (CAPB)). Examples of surfactants include alkyl sulfates and alkyl ether sulfates (e.g., ammonium lauryl sulfate (ALS) and sodium laureth sulfate (SLES)), acyl lactylates, sarcosinates, isethionates, taurates, sulphosuccinates, olefin sulfonates, amine oxides, alkanolamides (e.g., cocamide DEA and lauramide DEA), ethoxylated alkanolamides (PEG06 cocamide and PEG-6 lauramide) and alkyl polyglycosides. Formulations for cleansing formulation bases are well known to those having ordinary skill in the art.

Such a kit also contains at least one packaged additive, such as at least one fragrance, at least one colorant, or at least one active constituent. In certain cases, the cleansing formulation base is apportionable into single use amounts and the number of individually packaged additives is equal to at least the number of single uses of the base.

A kit for a customizable conditioner can include a hair moisturizing base, formulations for which are well known to those having ordinary skill in the art. The hair moisturizing base can be in liquid or gel form. Such a kit can also contain at least one packaged additive, such as at least one fragrance, as described previously and below.

Similarly, a kit for a customizable body wash, body gel, or body scrub can include an appropriate formulation base, e.g., a cleaning formulation base, as known to those having ordinary skill in the art, and at least one packaged additive. The at least one packaged additive can be any as described previously, e.g., a fragrance, a colorant, a texture modifier, etc. For example, in one embodiment, a kit for a customizable body wash can include a cleansing body wash formulation base, and one or more packaged fragrance additives, e.g., raspberry, jasmine, lavender, cucumber melon, apricot, rose, rosemary, ginger, vanilla, hazelnut, gardenia, hibiscus, mango, ocean breeze, freesia, honeysuckle, watermelon, orange, lemon, mint, lily of the valley, green tea, etc.

Kits for customizable facial and/or body creams are also envisioned. Such kits can include an appropriate formulation base, e.g., a moisturizing base, as known to those having ordinary skill in the art, and at least one packaged additive. The at least one packaged additive can be any as described previously. In one embodiment, a kit for a customizable facial and/or body cream includes a moisturizing base and one or more packaged fragrance additives, as described previously.

Kits for customizable facial cosmetics are also provided. For example, a kit for a customizable lip gloss can include a lip gloss base, with one or more packaged additives, such as flavorants, colorants, or fragrances. Similarly, a kit for a customizable eye shadow can include an eye shadow powder base, with one or more packaged additives, e.g., colorants. Eye shadow powder bases and lip gloss bases are known to those having ordinary skill in the cosmetic and beauty industry arts.

Kits for customizing a body fragrance, such as a perfume, cologne, eau de cologne, or eau de toilette, are also provided. A kit for a customizable perfume can include a solvent base, and one or more packaged additives, such as fragrances. A fragrance can include one or more essential oils. A solvent base can include one or more fixatives, e.g., to depress the rate of evaporation of a fragrance, such as phtalates and glycerin. A solvent base can include alcohols, such as ethyl alcohol. A solvent base can include water. A fragrance can be any fragrance described previously, and may include one or more essential oils. An essential oil can be, without limitation, lemon, orange, grapefruit, lime, verbena, bergamot, spearmint, peppermint, coriander, palmarosa, patchouli, vetiver, frankincense, cedarwood, sandalwood, majoram, basil, rosemary, rose, geranium, lavender, ylang ylang, and pettigrain. Solvent bases, fragrances, essential oils, and methods for using the same to prepare body fragrances are well known to those having ordinary skill in the art.

Kits and Packaging

According to exemplary articles of the invention, a kit for preparing a customizable food or personal care product is provided that comprises a base component and at least one additive packaged separately from the base component. The additive package can be physically attached to the base component or included in the base component's packaging, e.g., included in a box or package that includes the base component. The attachment is preferably removable so that an additive can be conveniently detached, opened, and then combined with the base component.

The total amount of additive, whether provided in separate apportioned packages or in a single package, is preferably sufficient to enhance or modify a characteristic of the total amount of the base component. As a simple illustrative example, ajar having 100 milliliters of liquid, where one serving is intended to be 10 mL of liquid, can be packaged with 10 flavor packets. Each flavor packet can contain an effective amount of flavor to achieve a desired flavor once it is combined with the 10 mL of liquid. Each of the flavor packets can all be the same flavor, but conveniently, they can be a variety or an assortment of flavors individually packaged. Alternatively, one or more additives can be provided in separately contained pre-measured packages. For example, in the embodiment just described, the packages can contain 5 flavor packets, 3 colorant packets, and 2 packets of gelling agents. The contents of these packets can also be provided so that they are also compatible for combining with each other.

Optionally, an additive can be packaged with a base component using a holder attached to the base component's container, or integrally part of the container. The holder can be dimensioned to carry a specific number of additive packages. An exemplary holder can be a bag that hangs from the neck of a bottle, or a sturdy container configured to hold both the base component and additive packages. Preferably it can be convenient for a holder to be adapted to hold a quantity of additive packages useful for the total number of servings or the total weight or volume of the base component.

Referring now to FIG. 1A, a customizable food kit 100 is illustrated. Product 100 includes a base 10 contained within a container 20. A holder 30, can be removably attached to container 20. This non-limiting example of a product design allows a user to pick and choose which additives are desirably combinable with base 10. Packaged product 100 can be designed so that it is suitable for placing one or more packaged additives 40 in holder 30—additives chosen by, for example, the consumer or pre-selected by the manufacturer or retailer. Another alternative packaging design for a kit is depicted in FIG. 1B, where a base component 11 is held within container 21 and a second container 31 holding packaged additives 41 can be removable attached to container 21. Container 31 can be attached to container 21 by any known method or technique such as, but not limited to, locking, hanging, sliding, adhering using adhesive, snapping, etc. In FIG. 1B, a lip 61 of container 31 can be hung from a side or lip 51 of base item container 21. Optionally, more than one package 31 can be positioned adjacent to base component container 21, such as by placing another package similar to that of container section 31 on another side or lip of container 21. In another embodiment, a kit can be packaged in a container where container sections 21 and 31 are manufactured or formed together, such as in a uni-body design. Similar packaging designs can be envisioned for customizable personal care products.

Additives can be provided in individualized pre-determined portions. Pre-measured amounts, for example, can be provided suitable for portioned servings, such as single servings, family size, single use amounts, or customary amounts necessary for a particular use. Amounts of pre-measured additive can also correlate to effective amounts for achieving a desired alteration of the base component. For example, an effective amount of preservative packaged with a liquid base item to enhance the liquid's shelf stability can be a pre-measured additive. One additive package could therefore be combined with a specified amount of base component to provide a product that can be shelf stable for 2 days, for example, while another additive package containing a different amount or type of preservative can be used to provide a product whose shelf life is one week, for example. Such a system provides made-to-order-like formulations that can satisfy a user's diverse needs.

Various packaging configurations can be used to contain an additive. The additive can be packaged alone or in combination with the base component. In an aspect, an additive can be provided in a package having tear-away portions that leave unused portions intact while one portion is separated for immediate use. Other options include, without limitation, packets, vials, pouches, capsules, envelopes, cartons, tubes, jars, bottles, and the like. These can be bundled, contained, taped, hooked, glued, or tied together.

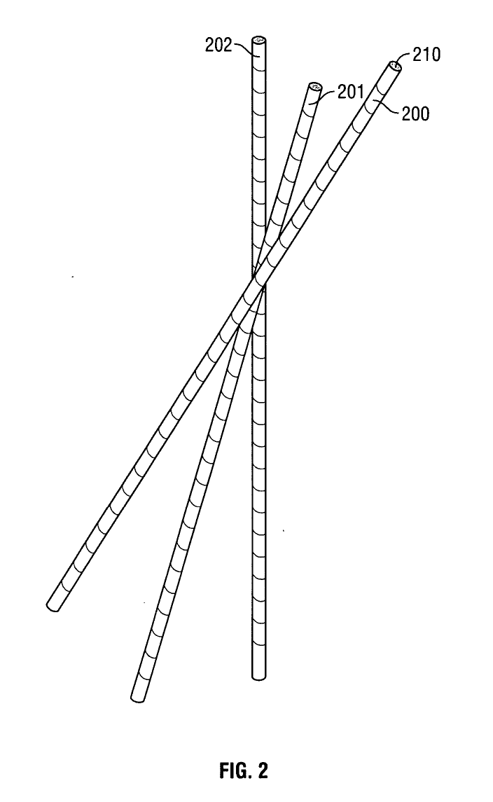

In one embodiment according to the invention, a kit for preparing a nutritional supplement product can be provided having (1) an unflavored or plain solid, powder or liquid dietary supplement base component packaged in its own container, and (2) at least one flavor packet attached to the dietary supplement container. The dietary supplement base component can include, among other things, proteins, peptides, amino acids, and combinations thereof. The base can be, for example, a protein powder or nutrition shake mix, and the flavor packet can be a sealed package or pouch. One suitable package configuration for a flavor powder is a sealed but openable straw-like package 200, as illustrated in FIG. 2. In another aspect, the product can include a plurality of flavor packets, preferably equal to the amount of servings in the container (of base dietary supplement). Packaged in the exemplary configuration of a filled straw 200, flavorant 210 can be conveniently bundled and packaged in a kit. A plurality of packages 200, 201, 202 can be provided. Having more than one type of flavor packet, 200-202, advantageously offers the consumer a way to tailor his or her choice of flavor of the product, from serving to serving. In an alternative configuration, the base item's container can have a holder in which the consumer places flavor packets he or she chooses from an array of packets. The holder can be dimensioned to fit a number of packets equal to the total number of servings of the container of dietary supplement. Such a customizable kit allows a consumer to thereby enjoy an unlimited variety of flavors by merely purchasing one container of a base consumable.

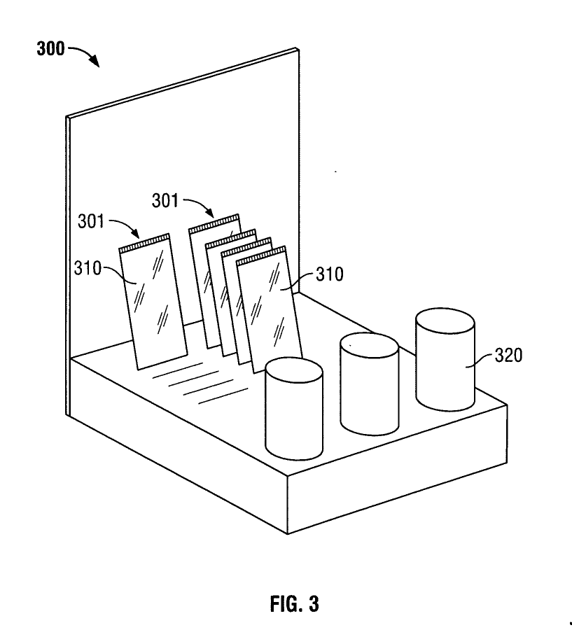

FIG. 3 provides a further embodiment according to the invention, whereby a system such as a rack 300 or array of additives and base items are presented. Additives 301 can be provided in individual packages 310 and be displayed in close proximity or adjacent to corresponding base item(s) 320. Base item 320 can include more than one portion or serving. Various additives can be provided such as those described above. A user can therefore advantageously pick and choose which additive(s) from system 300 to add to complete a custom kit, based on his or her own preference and discretion. Within package 310, pre-measured portions (not shown) can be included. This feature can be particularly advantageous, as it allows a user to enjoy the enhanced product with one additive, or in various combinations by merely combining one or more types of additives, and in various amounts if desired. Thus, by choosing a multitude of additive types, kinds, versions, etc., a large number of combinations can be made from one base consumable. In particular, depending on the number of additives chosen, the number of different combinations or variations resulting from a base combined with at least one additive equals the factorial value calculated from the number of additives.

A number of embodiments of the invention have been described. Nevertheless, it will be understood that various modifications may be made without departing from the spirit and scope of the invention. Accordingly, other embodiments are within the scope of the following claims.

1. A kit for making a customizable food comprising:
a base component; and
a plurality of packaged additives,
wherein each of the plurality of packaged additives are packaged separately from the base component, and wherein each of the plurality of packaged additives, when combined individually with a portion of the base component at a time after the manufacture of both the base component and the additive, alters a characteristic of the portion of the base component.

2. The kit of claim 1, wherein the plurality of packaged additives are selected, individually, from the group consisting of a colorant, a flavorant, a texturizer, a preservative, and combinations thereof.

3. The kit of claim 1, wherein the characteristic altered by the plurality of packaged additives is selected, individually, from the group consisting of taste, color, size, shelf life, smoothness, ingredient concentration, and combinations thereof.

4. The kit of claim 1, wherein the plurality of packaged additives are each, individually, flavorants.

5. The kit of claim 1, wherein the base component is contained in a first package and the plurality of packaged additives are held adjacent to the first package.

6. The kit of claim 1, wherein the base component and the plurality of packaged additives are combined into one package.

7. The kit of claim 1, wherein the base component is in a form selected from a group consisting of a solid, semi-solid, gel, liquid, or powder.

8. The kit of claim 1, wherein the base component is contained in a package, the package comprising a holder adapted to hold the plurality of packaged additives.

9. The kit of claim 8, wherein the holder is integral with the base component package.

10. A kit for making a nutritional supplement comprising:
a dietary supplement base; and
at least one additive, wherein the additive is packaged separately from the dietary supplement product.

11. The kit of claim 10, wherein the at least one additive when combined with the dietary supplement product, at a time after the manufacture of both the dietary supplement product and the additive, alters a characteristic of the dietary supplement product.

12. The kit of claim 10, wherein the at least one additive is a flavorant, and wherein the at least one additive, when combined with the dietary supplement, provides a flavored blend.

13. The kit of claim 12, wherein the flavorant is selected from the group consisting of vanilla, chocolate, butterscotch, peanut butter, mocha, strawberry, banana, peach, orange, cherry, blueberry, raspberry, mango, apple, pineapple, grape, mint, caramel, cinnamon and combinations thereof.

14. The kit of claim 10, wherein the dietary supplement product comprises a material selected from a group consisting of proteins, peptide, amino acids, carbohydrates, electrolytes, herbs, nutraceuticals, nutrients, pharmaceuticals, and combinations thereof.

15. The kit of claim 10, wherein the at least one additive comprises a material selected from the group consisting of proteins, peptide, amino acids, carbohydrates, electrolytes, herbs, nutraceuticals, nutrients, pharmaceuticals, and combinations thereof.

16. The kit of claim 10, wherein the dietary supplement product is a powder, liquid, semi-solid, gel, or solid.

17. The kit of claim 10, further comprising a plurality of individually packaged additives.

18. The kit of claim 17, wherein the dietary supplement product is apportionable into single servings and the number of individually packaged additives is equal to at least the number of single servings of the dietary supplement product.

19. A kit for making a flavored marinade comprising:
a base component comprising oil and vinegar; and
at least one flavorant additive, wherein the at least one flavorant additive is packaged separately from the base component, and wherein the at least one flavorant additive, when combined with the base component at a time after the manufacture of both the base component and the flavorant additive, alters a flavor characteristic of the base component.

20. The kit of claim 19, wherein the flavorant additive is selected from the group consisting of soy sauce, balsamic vinegar, brown sugar, and lemon peel.

21. The kit of claim 19, comprising a plurality of individually packaged flavorant additives.

22. The kit of claim 21, wherein the base component is apportionable into single servings and the number of individually packaged additives is equal to at least the number of single servings of the base component.

23. A kit for making a flavored medicine comprising:
a base medicine component; and
at least one flavorant additive, wherein the at least one flavorant additive is packaged separately from the base medicine component, and wherein the at least one flavorant additive, when combined with the base medicine component at a time after the manufacture of both the base medicine component and the flavorant additive, alters a flavor characteristic of the base medicine component.

24. The kit of claim 23, wherein the at least one flavorant additive is selected from the group consisting of vanilla, chocolate, butterscotch, peanut butter, mocha, strawberry, banana, peach, orange, cherry, blueberry, raspberry, mango, apple, pineapple, grape, mint, caramel, cinnamon and combinations thereof.

25. The kit of claim 23, comprising a plurality of individually packaged flavorant additives.

26. The kit of claim 23, wherein the base medicine component is a liquid, powder, gel, semi-solid, or solid.

27. A kit for making a customizable personal care product comprising:
a base component; and
one or more packaged additives;
wherein each of the one or more packaged additives are packaged separately from the base component, and wherein each of the one or more packaged additives, when combined individually with a portion of the base component at a time after the manufacture of both the base component and the additive, alters a characteristic of the portion of the base component.

28. The kit of claim 27, wherein the packaged additives are selected, individually, from the group consisting of a fragrance, colorant, a flavorant, a texturizer, a preservative, and combinations thereof.

29. The kit of claim 27, wherein the characteristic altered is selected, individually, from the group consisting of taste, color, size, shelf-life, smoothness, ingredient concentration, fragrance, and combinations thereof.

30. The kit of claim 27, wherein the customizable personal care product is selected from a shampoo, a conditioner, a body wash, a body gel, a body scrub, a body cream, a facial cream, a lip gloss, an eye shadow, and a body fragrance.
